(19) United States
(12) Patent Application Publication
(10) Pub. No.: US 2004/0071287 A1
(43) Pub. Date: Apr. 15, 2004

(54) Encryption circuit arrangement and method therefor

(76) Inventor: Daxon K. Alexander, Richmond, VA (US)

Correspondence Address: PHILIPS ELECTRONICS NORTH AMERICA CORPORATION, INTELLECTUAL PROPERTY & STANDARDS, 1109 MCKAY DRIVE, M/S-41SJ, SAN JOSE, CA, 95131, US

(21) Appl. No.: 10/270,027

(22) Filed: Oct. 11, 2002

(51) Int. Cl. H04L 9/00

(52) U.S. Cl. 380/29

(57) ABSTRACT

A column transformation for an encryption application is effected using XOR operations. According to an example embodiment of the present invention, an input column of bytes is transformed for the AES algorithm. An output column of transformed bytes is provided by logically combining (e.g, XORing) at least one bit from each byte in the input column. The transformed bytes may be implemented with the MixColumns transformation for the AES algorithm, such that the logical combination discussed above is used in place of the logical combination and multiplication used in the MixColumns transformation. With this approach, the Finite Field multiplication specified in the MixColumns transformation can be avoided and an equivalent transformation can be effected using only a single type of logic combination.

### FIELD OF THE INVENTION

The present invention is directed to cryptography and, more particularly, to circuit arrangements and implementations involving high-speed encryption.

### BACKGROUND

Encryption circuitry and algorithms have been designed for a wide range of applications, such as for data protection and identification cards, and have been used to protect many different types of data. For a variety of reasons, many of these applications have been directed to the use of Advanced Encryption Standard (AES)-based encryption, which has its origins with the National Institute of Standards and Technology (NIST), or other encryption standards, such as DES (Data Encryption Standard) or IDEA (International Data Encryption Standard). The AES encryption algorithm is a symmetric block cipher that can encrypt (encipher) and decrypt (decipher) information, and is capable of using cryptographic keys of 128, 192 and 256 bits to encrypt and decrypt data in blocks of 128 bits. Encrypting data converts the data to an unintelligible form called ciphertext, and decrypting data converts the data back into its original form, called plaintext.

AES-based encryption involves transformations including the ByteSubstitution, ShiftRows and MixColumns transformations. MixColumns transformations typically take all of the columns of a State (a two-dimensional array of bytes) and mix their data independently of one another to create new columns. This mixing of data uses an algorithm that involves lookup tables and/or a process that calculates logarithms of multiplication factors and invokes anti-logarithmic values of a sum of two logarithms to determine a multiplication product. For general information regarding the AES, and for specific information regarding implementations to which various example embodiments of the present invention may be applicable, reference may be made to the Federal Information Processing Standard (FIPS) publication 197 of Nov. 26, 2001, entitled “Announcing the Advanced Encryption Standard (AES),” which is attached hereto as Appendix B and fully incorporated herein by reference.

Circuitry and algorithms used to implement the MixColumns transformation typically involve combinatorial logic circuits that are relatively large and slow as a result of propagation delay. As the demand for high-speed circuit applications continues to increase, relatively slow MixColumns transformations have presented challenges to the implementation of encryption and encryption circuitry.

### SUMMARY OF THE INVENTION

Various aspects of the present invention are directed encryption, and in a more specific application, to encryption involving relatively low propagation delay.

According to one example embodiment of the present invention, each of four input bytes of data in a column of an AES State is transformed into an output byte via logical combination of at least one bit from each of the four input bytes, each of the input and output bytes having N bits. The transformation is effected without necessarily multiplying a plurality of the input bytes by respective coefficients, such that a single logical combination type (e.g., an XOR or an XNOR operation) can be used. With this approach, difficulties associated with encryption, including those discussed above in connection with data mixing, can be addressed.

According to another example embodiment of the present invention, a circuit arrangement is programmed for transforming a column of data in the AES algorithm (e.g., replacing the MixColumns transformation) using XOR gates on selected bits in the column to generate an output column of bits without necessarily using Finite Field multiplication. With this approach, the XORed output can be implemented using fewer gates than typically required for implementation of the conventional AES MixColumns transformation.

The above summary of the present invention is not intended to describe each illustrated embodiment or every implementation of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a flow diagram for encrypting data, according to an example embodiment of the present invention; and

FIG. 2 is a circuit arrangement for encrypting data, according to another example embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF VARIOUS EXAMPLE EMBODIMENTS

The present invention is believed to be highly applicable to methods and arrangements for encryption, such as data encryption involving AES-type circuits and methods. The invention has been found to be particularly advantageous for relatively high-speed transformation of data for encryption, such as during mix columns transformations for AES-type encryption. While the present invention is not necessarily limited to such applications, an appreciation of various aspects of the invention is best gained through a discussion of examples in such an environment.

According to an example embodiment of the present invention, a combinatorial logic circuit including a plurality of XOR (exclusive OR) gates is programmed to execute MixColumns data transformations for the AES-based encryption standard. Conventionally, the MixColumns transformation involves multiplying a column in an AES State by one or more of bytes (represented in hexadecimal form) 01, 02, 02, 09, 0b, 0d, and 0e in the finite Galois Field. This example embodiment, which may be implemented in connection with the conventional approach discussed above, involves implementing multiplication procedures for the MixColumns transformation using XOR gates to provide an output of various bits in an input column of a State (e.g., two-dimensional arrays of bytes). Specifically, selected bits in the input column of the State are combined using an XOR operation to effect the MixColumns transformation without necessarily using multiplication. This XORed transformation is relatively faster than the conventional approach and may be implemented, for example, using relatively small circuit arrangements that require less space and power than circuit arrangements conventionally used for MixColumns transformations.

The above approach is useful for overcoming a variety of challenges to conventional encryption approaches, and is particularly useful for forward (MixColumns) and inverse (InvMixColumns) transformations, as discussed above. For example, the XORed output is arrived at using fewer XOR gates, relative to the number of XOR gates used in conventional MixColumns transformations for AES-based encryption. In addition, the transformation can be carried out without necessarily using lookup tables typically used, for example, in AES MixColumns transformations. Furthermore, the transformation does not necessarily require complex mathematical processes used in conventional MixColumns transformations, such as those that calculate logarithms of multiplication factors and invoke anti-logarithmic values of the sum of two logarithms to determine a multiplication product. With this approach, combinatorial logic circuits used in the implementation of the transformation use relatively few gates and, therefore, exhibit relatively low propagation delay. For more information regarding the AES and MixColumns transformations, reference may be made to the above-referenced publication entitled “Announcing the Advanced Encryption Standard (AES).”

The above approach is further applicable for encryption of a plurality of data types. For example, communications data, such as voice, video and email data, can be encrypted and protected during transmission. Other data, such as electronic files and sensitive documents, can be encrypted, stored and/or transmitted in a protected format. Moreover, the relatively fast decryption time and simple decryption circuitry are useful for implementing the above encryption approach in applications where speed, circuit expense and power consumption are concerns.

In one implementation, the input and output for the AES algorithm each consist of sequences of 128 bits (digits with values of 0 or 1). These sequences may be referred to as blocks and the number of bits they contain may be referred to as their length. Cipher Keys used in connection with the AES algorithm are typically a sequence of 128, 192 or 256 bits. The bits within such sequences are numbered starting at zero and end at one less than the sequence length (block length or key length), e.g., such that a sequence of 128 bits are numbered 0-127. Encryption operations are performed on the State, with each column in the State having four bytes that form 32-bit words. These encryption operations include the MixColumns transformation, which operates on the State column-by-column, treating each column as a four-term polynomial and mixes the data in each column to produce a new column of data.

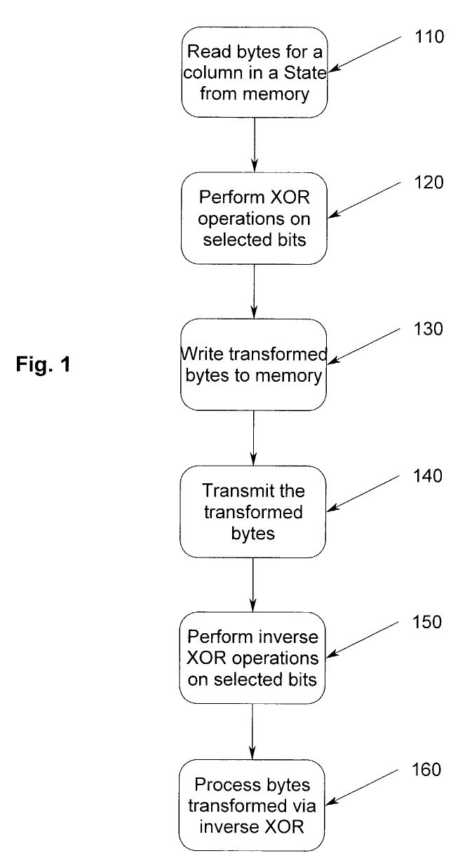

FIG. 1 is a flow diagram for encrypting data, according to a more particular example embodiment of the present invention. At block 110, a column of bytes in a State is read from memory, and XOR operations are performed on selected bits from one or more of the bytes at block 120. The output of the XOR operations is used to define bits in a column of transformed bytes. The transformed bytes are written to memory at block 130 and subsequently transmitted for use at a different location at block 140. In an alternate implementation, the transmission step at block 140 is omitted, and the transformed bytes are held in the memory. Inverse XOR operations are performed on each of the transformed bytes at block 150. The inverse XOR operations decrypt the transformed bytes back into their original form, and the inverse-transformed bytes are processed at block 160 for use in a variety of implementations.

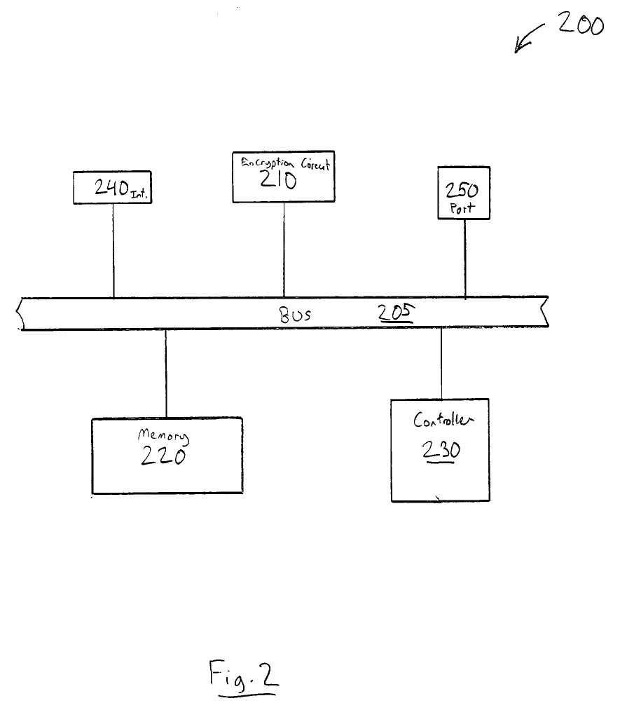

FIG. 2 is a circuit arrangement 200 for encrypting data, according to another example embodiment of the present invention. The circuit arrangement 200 includes a communications bus 205 adapted to communicatively couple to a plurality of circuit elements. Circuit elements shown include an encryption circuit 210, a memory 220, a circuit controller 230, a user interface device 240 and a communications port 250. One or more of these circuit elements are used in various implementations of the circuit arrangement 200, with the bus 205 being adapted to couple to additional elements (e.g., as typically employed in a computer).

The circuit arrangement 200 may be programmed using one or more of a variety of programming languages and techniques. For instance, Verilog or VHDL hardware design languages may be used. In one implementation, the circuit controller 230 is programmed to read data bits of a column of a State from the memory 220 and to cause the data bits to be processed at the encryption circuit 210. The encryption circuit 210 provides an output of transformed bytes from the column using XOR operations on selected ones of the data bits read from the memory 220, such as discussed above. Bits transformed at the encryption circuit 210 are then stored in the memory 220 for further use/processing.

In a more particular implementation, transformed bytes are transferred via the communications port 250 (e.g., a modem, USB port or other commonly-available communications port). In another more particular implementation, user inputs at the user interface 240 are used for directing the encryption and/or transmittal data bits from the memory 220. For example, the user inputs can be used to program encryption process effected by the controller 230. In still another implementation, the controller uses the memory 220 for storing programming data.

In another example embodiment of the present invention, a cryptographic chip is adapted for performing XOR operations on a column of bytes for an AES MixColumns transformation, for example, in a manner similar to those discussed above. The chip includes a plurality of XOR gates and a controller adapted for XORing selected bits in a column to produce an output column of bytes. For example, one type of cryptographic chip arrangement to which the present invention may be applicable is the PTD 3000 chip available from Philips Semiconductors, Inc., of Sunnyvale, Calif.

In another example embodiment of the present invention, forward and/or inverse MixColumns transformations are effected using XOR operations on bytes in a column of the State as detailed in Tables 1 and 2 below. For example, the controller 230 of FIG. 2 may be programmed to effect these XOR operations. Bytes in a column of the State to be transformed are represented by a, b, c and d, and one byte in the column (e) after forward and inverse MixColumns transformations is represented as shown in Tables 1 and 2, respectively. The subscripts following the letter indicate the positions of the bit with 7 standing for the most significant bit and 0 for the least significant bit, and the symbol “⊕” indicates an XOR operation.

Table 1 shows a forward transformation of a byte in a column as follows:

TABLE 1
Forward MixColumns Transform

| | | | | | | | | | | | | | | |
|---|---|---|---|---|---|---|---|---|---|---|---|---|---|---|
| e₇ | = | a₆ | ⊕ | b₆ | ⊕ | b₇ | ⊕ | c₇ | ⊕ | d₇ | | | | |
| e₆ | = | a₅ | ⊕ | b₅ | ⊕ | b₆ | ⊕ | c₆ | ⊕ | d₆ | | | | |
| e₅ | = | a₄ | ⊕ | b₄ | ⊕ | b₅ | ⊕ | c₅ | ⊕ | d₅ | | | | |
| e₄ | = | a₃ | ⊕ | a₇ | ⊕ | b₃ | ⊕ | b₄ | ⊕ | b₇ | ⊕ | c₄ | ⊕ | d₄ |
| e₃ | = | a₂ | ⊕ | a₇ | ⊕ | b₂ | ⊕ | b₃ | ⊕ | b₇ | ⊕ | c₃ | ⊕ | d₃ |
| e₂ | = | a₁ | ⊕ | b₁ | ⊕ | b₂ | ⊕ | c₂ | ⊕ | d₂ | | | | |
| e₁ | = | a₀ | ⊕ | a₇ | ⊕ | b₀ | ⊕ | b₁ | ⊕ | b₇ | ⊕ | c₁ | ⊕ | d₁ |
| e₀ | = | a₇ | ⊕ | b₀ | ⊕ | b₇ | ⊕ | c₀ | ⊕ | d₀ | | | | |

Table 2 shows a reverse transformation of bytes to be inverse-transformed (e.g, bytes a, b, c and d are transformed bytes, with the column thereof being inverse-transformed) on the following page:

TABLE 2
Inverse MixColumns Transform

| | | | | | | | | | | | | | | |
|---|---|---|---|---|---|---|---|---|---|---|---|---|---|---|
| e₇ | = | a₄ | ⊕ | a₅ | ⊕ | a₆ | ⊕ | b₄ | ⊕ | b₆ | ⊕ | b₇ | ⊕ | c₄ |
| | | | ⊕ | c₅ | ⊕ | c₇ | ⊕ | d₄ | ⊕ | d₇ | | | | |
| e₆ | = | a₃ | ⊕ | a₄ | ⊕ | a₅ | ⊕ | a₇ | ⊕ | b₃ | ⊕ | b₅ | ⊕ | b₆ |
| | | | ⊕ | b₇ | ⊕ | c₂ | ⊕ | c₃ | ⊕ | c₅ | ⊕ | c₆ | ⊕ | d₃ |
| | | | ⊕ | d₆ | ⊕ | d₇ | | | | | | | | |
| e₅ | = | a₂ | ⊕ | a₃ | ⊕ | a₄ | ⊕ | a₆ | ⊕ | b₂ | ⊕ | b₄ | ⊕ | b₅ |
| | | | ⊕ | b₆ | ⊕ | b₇ | ⊕ | c₂ | ⊕ | c₃ | ⊕ | c₅ | ⊕ | c₆ |
| | | | ⊕ | d₂ | ⊕ | d₅ | ⊕ | d₆ | ⊕ | d₇ | | | | |
| e₄ | = | a₁ | ⊕ | a₂ | ⊕ | a₃ | ⊕ | a₅ | ⊕ | b₁ | ⊕ | b₃ | ⊕ | b₄ |
| | | | ⊕ | b₅ | ⊕ | b₆ | ⊕ | b₇ | ⊕ | c₁ | ⊕ | c₂ | ⊕ | c₄ |
| | | | ⊕ | c₅ | ⊕ | c₇ | ⊕ | d₁ | ⊕ | d₄ | ⊕ | d₅ | ⊕ | d₆ |
| e₃ | = | a₀ | ⊕ | a₁ | ⊕ | a₂ | ⊕ | a₅ | ⊕ | a₆ | ⊕ | b₀ | ⊕ | b₂ |
| | | | ⊕ | b₃ | ⊕ | b₅ | ⊕ | c₀ | ⊕ | c₁ | ⊕ | c₃ | ⊕ | c₅ |
| | | | ⊕ | c₆ | ⊕ | c₇ | ⊕ | d₀ | ⊕ | d₃ | ⊕ | d₅ | ⊕ | d₇ |
| e₂ | = | a₀ | ⊕ | a₁ | ⊕ | a₆ | ⊕ | b₁ | ⊕ | b₂ | ⊕ | b₆ | ⊕ | b₇ |
| | | | ⊕ | c₀ | ⊕ | c₂ | ⊕ | c₆ | ⊕ | d₂ | ⊕ | d₆ | ⊕ | d₇ |
| e₁ | = | a₀ | ⊕ | a₅ | ⊕ | b₀ | ⊕ | b₁ | ⊕ | b₅ | ⊕ | b₆ | ⊕ | b₇ |
| | | | ⊕ | c₁ | ⊕ | c₅ | ⊕ | c₇ | ⊕ | d₁ | ⊕ | d₅ | ⊕ | d₆ |
| e₀ | = | a₅ | ⊕ | a₆ | ⊕ | a₇ | ⊕ | b₀ | ⊕ | b₅ | ⊕ | b₇ | ⊕ | c₀ |
| | | | ⊕ | c₅ | ⊕ | c₆ | ⊕ | d₀ | ⊕ | d₅ | | | | |

### Experimental Results

For general information regarding data encryption, and for specific information regarding experimental results to which various example embodiments of the present invention, including those discussed above, may be applicable, reference may be made to attached Appendix A, which is fully incorporated herein by reference.

The present invention should not be considered limited to the particular examples described above. For example, the XOR operations can be replaced by XNOR (exclusive-nor) operations with corresponding mathematical changes to arrive at the same result. Various modifications, equivalent processes, as well as numerous structures to which the present invention may be applicable fall within the scope of the present invention, as fairly set forth in the appended claims.

What is claimed is:

1. For each of four input bytes of data in a column of an AES State, each input byte having N data bits, a method for transforming the data into an output byte also having N bits, the method comprising:
generating each of the N bits of the output byte by logically combining at least one of the N data bits from each of four input bytes of data and without multiplying a plurality of the input bytes by respective coefficients.

2. The method of claim 1, wherein generating each of the N bits of the output byte is performed without multiplying any coefficients.

3. The method of claim 1, wherein generating each of the N bits of the output byte is performed without multiplying any finite field elements.

4. The method of claim 1, wherein generating each of the N bits of the output byte is performed without multiplying any of the input bytes.

5. The method of claim 1, wherein generating each of the N bits of the output byte is performed without any multiplication.

6. The method of claim 1, wherein logically combining is performed using only one type of logical operation.

7. The method of claim 1, wherein logically combining is performed using an XOR logical operation.

8. The method of claim 1, wherein an XOR logical operation includes at least one of: an inverted XOR logical operation; and a noninverted XOR logical operation.

9. The method of claim 1, wherein logically combining is performed using only XOR operations.

10. The method of claim 1, wherein generating each of the N bits of the output byte is performed using only XOR operations.

11. The method of claim 1, wherein generating the output byte is performed according to the equations illustrated in Table 1.

12. The method of claim 1, further including repeating the step of generating for each column of the AES State.

13. The method of claim 12, further including performing a reverse transformation on the output bytes by performing logically combinations using data bits from the respective output bytes of the columns of the AES State and without multiplying by respective coefficients.

14. The method of claim 13, wherein generating each of the N bits of the output byte is performed using only XOR operations.

15. The method of claim 1, wherein generating each of the N bits of the output byte is performed using only XOR operations, and further including repeating the step of generating for each column of the AES State.

16. The method of claim 1, further including performing steps according to an AES recommendation, and wherein generating each of the N bits of the output byte is performed consistent with AES recommendation.

17. For operation on each of four input bytes of data in a column of an AES State, each input byte having N data bits, a circuit arrangement for transforming the data into an output byte also having N bits, the circuit arrangement comprising:
generating means for generating each of the N bits of the output byte without multiplying a plurality of the input bytes by respective coefficients, the generating means including means for logically combining at least one of the N data bits from each of four input bytes of data.

18. For operation on each of four input bytes of data in a column of an AES State, each input byte having N data bits, a circuit arrangement for transforming the data into an output byte also having N bits, the circuit arrangement comprising:
a logic circuit configured and arranged to generate each of the N bits of the output byte by logically combining at least one of the N data bits from each of four input bytes of data and without multiplying a plurality of the input bytes by respective coefficients.

19. The circuit arrangement of claim 18, wherein the logic circuit is implemented using a programmable processor.

20. The circuit arrangement of claim 18, wherein the logic circuit is implemented using discrete circuitry.

21. The circuit arrangement of claim 18, wherein the logic circuit is implemented using semi-programmable circuitry.

22. The circuit arrangement of claim 18, without multiplying any coefficients.

23. The circuit arrangement of claim 18, without multiplying any finite field elements.

24. The circuit arrangement of claim 18, without multiplying any of the input bytes.

25. The circuit arrangement of claim 18, without any multiplication.

26. The circuit arrangement of claim 18, wherein the logic circuit is further configured and arranged to generate each of the N bits of the output byte by logically combining using only one type of logical operation.

27. The circuit arrangement of claim 18, wherein the logic circuit is further configured and arranged to generate each of the N bits of the output byte by logically combining using an XOR logical operation.

28. The circuit arrangement of claim 18, wherein the logic circuit is further configured and arranged to generate each of the N bits of the output byte by logically combining according to the equations illustrated in Table 1.

29. The circuit arrangement of claim 18, wherein the logic circuit is further configured and arranged to operate on each column of the AES State.

30. The circuit arrangement of claim 18, further including means for performing a reverse transformation on the output bytes by performing logically combinations using data bits from the respective output bytes of the columns of the AES State and without multiplying by respective coefficients.
